(19) United States
(12) Patent Application Publication
(10) Pub. No.: US 2003/0017282 A1
(43) Pub. Date: Jan. 23, 2003

(54) Plastic film wrap packaging box

(76) Inventor: Bae-Jou You, Chang Hau Hsien (TW)

Correspondence Address: BIRCH STEWART KOLASCH & BIRCH, PO BOX 747, FALLS CHURCH, VA, 22040-0747, US

(21) Appl. No.: 09/909,942

(22) Filed: Jul. 23, 2001

(51) Int. Cl. B32B 1/02

(52) U.S. Cl. 428/34.1

(57) ABSTRACT

A plastic film wrap packaging box includes a front side plate, a bottom plate, a rear side plate, an upper cover plate and a front side cover plate. The bottom plate has two sides respectively provided with elongate holes, and two enclosing plates on the two sides which extend outwardly and respectively to form securing plates corresponding to the enclosing plates and respectively having projecting portions. The two securing plates are folded toward inner sides of the box body to surround enclosing plates on two sides of each of the front side plates and the rear side plates such that the projecting portions are inserted into the elongate holes in the two sides of the bottom plate to enable the front side plate, the bottom plate and the rear side plate to form a box body.

### BACKGROUND OF THE INVENTION

(a) Field of the Invention

The present invention relates to a plastic film wrap packaging box, more particularly to a packaging box with a novel shape and structure.

(b) Description of the Prior Art

FIG. 10 shows a plastic film wrap packaging box disclosed in the inventor's R.O.C. Utility Model Application No. 088219459. Major disadvantages of the packaging box disclosed in said patent are that the side edges 2 require the use of adhesive to bond and secure them together, and that the front side 1 and the retaining hooks 3 on the two sides have a relatively large width, which makes the entire packaging box rather long.

### SUMMARY OF THE INVENTION

The main object of the present invention is to provide a plastic film wrap packaging box that can be assembled without the use of any adhesive, and that can have a reduced length as a whole.

According to one aspect of the present invention, the plastic film wrap packaging box includes a front side plate, a bottom plate, a rear side plate, an upper cover plate and a front side cover plate. The bottom plate has two sides respectively provided with elongate holes, and two enclosing plates on the two sides which extend outwardly and respectively to form securing plates corresponding to the enclosing plates and respectively having projecting portions. The two securing plates are folded toward inner sides of the box body to surround enclosing plates on two sides of each of the front side plates and the rear side plates such that the projecting portions are inserted into the elongate holes in the two sides of the bottom plate to enable the front side plate, the bottom plate and the rear side plate to form a box body.

According to another aspect of the present invention, the front side plate has a height lower than that of the rear side plate so as to form a suitable opening to facilitate pulling of plastic film wrap.

### BRIEF DESCRIPTION OF THE DRAWINGS

The foregoing and other features and advantages of the present invention will be more clearly understood from the following detailed description and the accompanying drawings, in which,

FIG. 1 is an exploded perspective view of the preferred embodiment of a plastic film wrap packaging box according to the present invention in an extended state;

FIG. 2 is a schematic perspective view of the preferred embodiment, showing that the front side plate folded 90 degrees upward and that the enclosing plates on the two sides of the front side plate are folded 90 degrees inward;

FIG. 3 is a schematic perspective view of the preferred embodiment, showing that the rear side plate, the cover plate and the front side cover plate are folded 90 degrees upward and that the enclosing plates on the two sides of the rear side plate are folded inward;

FIG. 4 is a schematic perspective view of the preferred embodiment, showing that the enclosing plate on the right side of the bottom plate is folded 90 degrees upward;

FIG. 5 is a schematic perspective view of the preferred embodiment, showing that the enclosing plates on the two sides of the bottom plate are folded 90 degrees upward and are folded toward the inside of the box body;

FIG. 6 is a schematic perspective view of the preferred embodiment, showing that the cover plate and the front side cover plate are folded 90 degrees such that they cover the box body;

FIG. 7 is a schematic perspective view of the preferred embodiment, showing that the enclosing plates on the two sides of the front side cover plate are folded 90 degrees downward;

FIG. 8 is a schematic perspective view of the preferred embodiment, showing that the front side cover plate is folded 90 degrees downward to cover the front side plate;

FIG. 9 is a schematic perspective view of the preferred embodiment, showing that the bottom portion of the preferred embodiment after being turned about 90 degrees; and

FIG. 10 is a schematic perspective view of the plastic film wrap packaging box disclosed in the inventor's R.O.C. Utility Model Application No. 088219459.

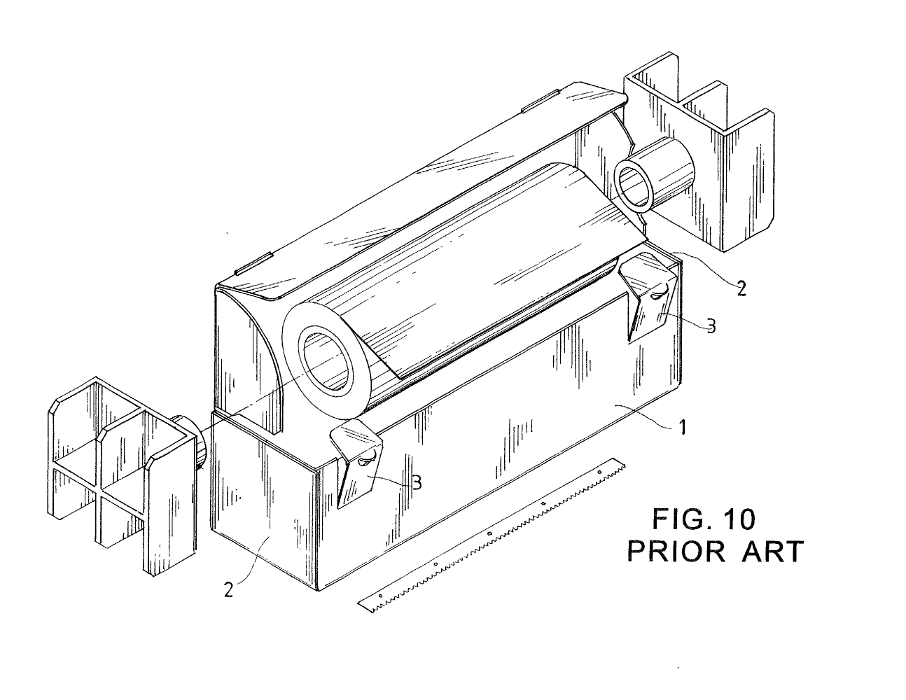

### DETAILED DESCRIPTION OF THE PREFERRED EMBODIMENT

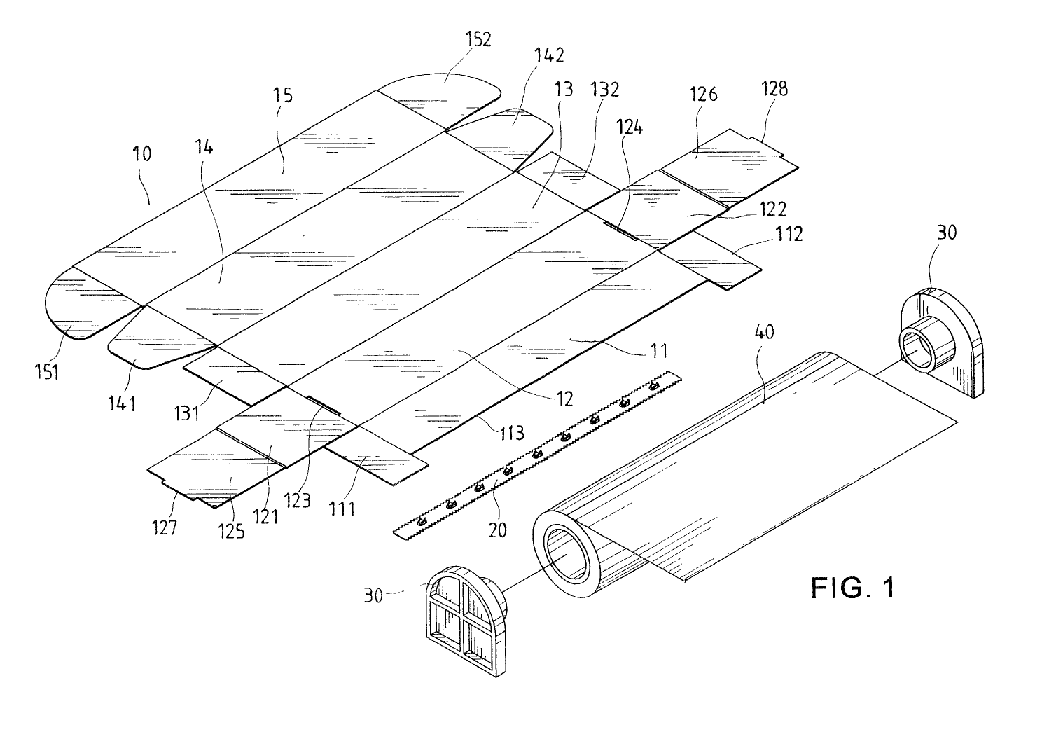

Referring to FIG. 1, the preferred embodiment of a plastic film wrap packaging box according to the present invention includes a rectangular box body 10, a cutting member 20, two support frames 30 and a roll of plastic film wrap 40.

The construction of the cutting member 20, the two support frames 30 and the plastic film wrap 40 have been described in the inventor's R.O.C. Utility Model Application No. 088219459. This invention is directed to the construction of the rectangular box body 10 such that the box body 10 can be assembled without the use of any adhesive.

As shown, the box body 10 includes a front side plate 11, a bottom plate 12, a rear side plate 13, an upper cover plate 14, and a front side cover plate 15. Two sides of the front side plate 11 are respectively provided with enclosing plates 111, 112. Two sides of the bottom plate 12 are respectively provided with enclosing plates 121, 122. Two sides of the rear side plate 13 are respectively provided with enclosing plates 131, 132. Two sides of the upper cover plate 14 are respectively provided with enclosing plates 141, 142. Two sides of the front side plate 15 are respectively provided with enclosing plates 151, 152. The invention is characterized in that the two sides of the bottom plate 12 are respectively provided with elongate holes 123, 124. The two enclosing plates 121, 122 respectively extend outwardly to form securing plates 125, 126 that respectively correspond to the enclosing plates 121, 122. Furthermore, distal ends of the outer sides of the two securing plates 125, 126 respectively have projecting portions 127, 128.

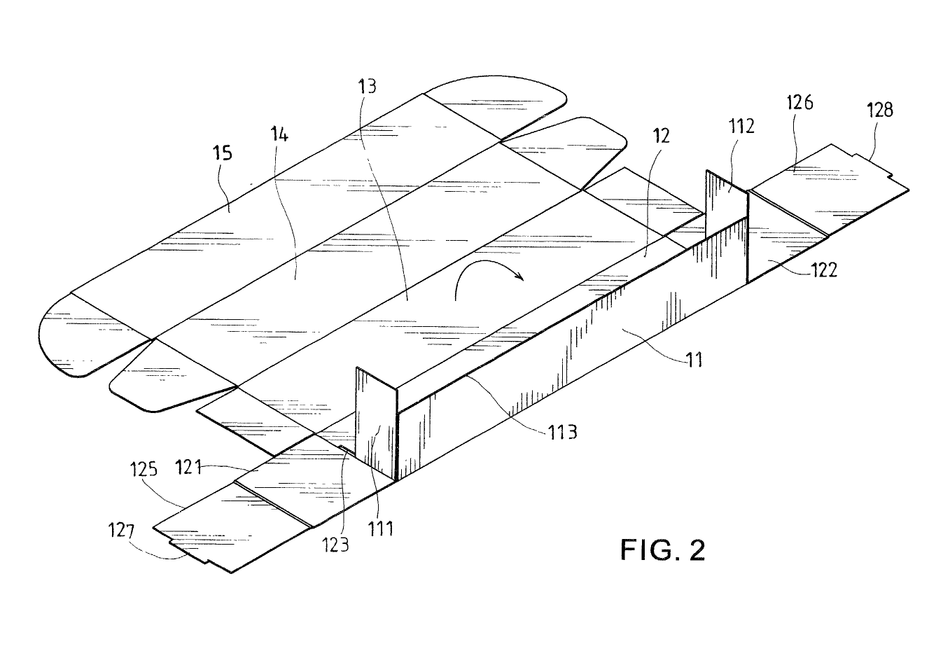

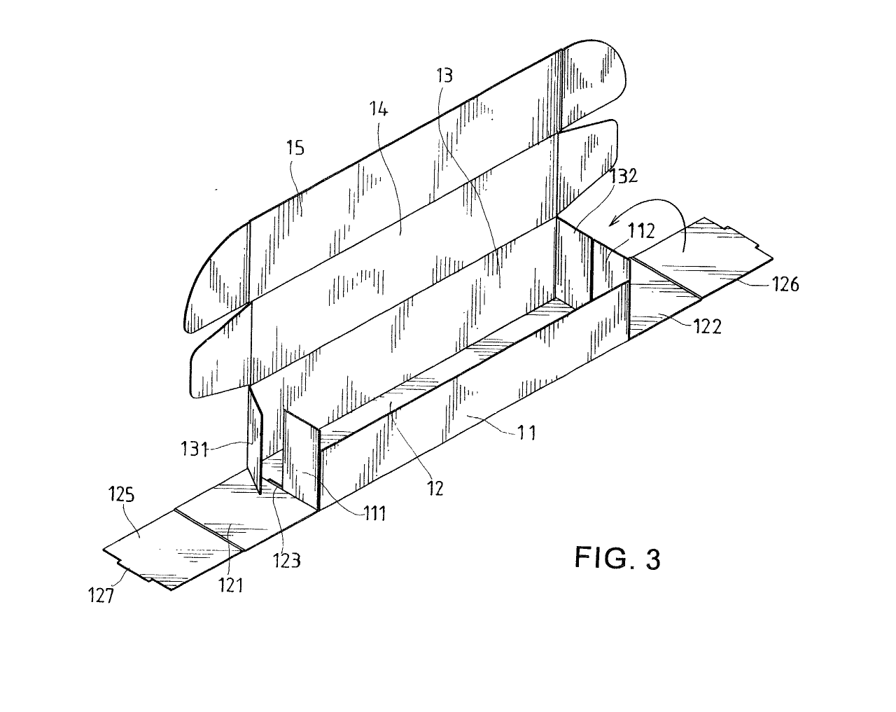

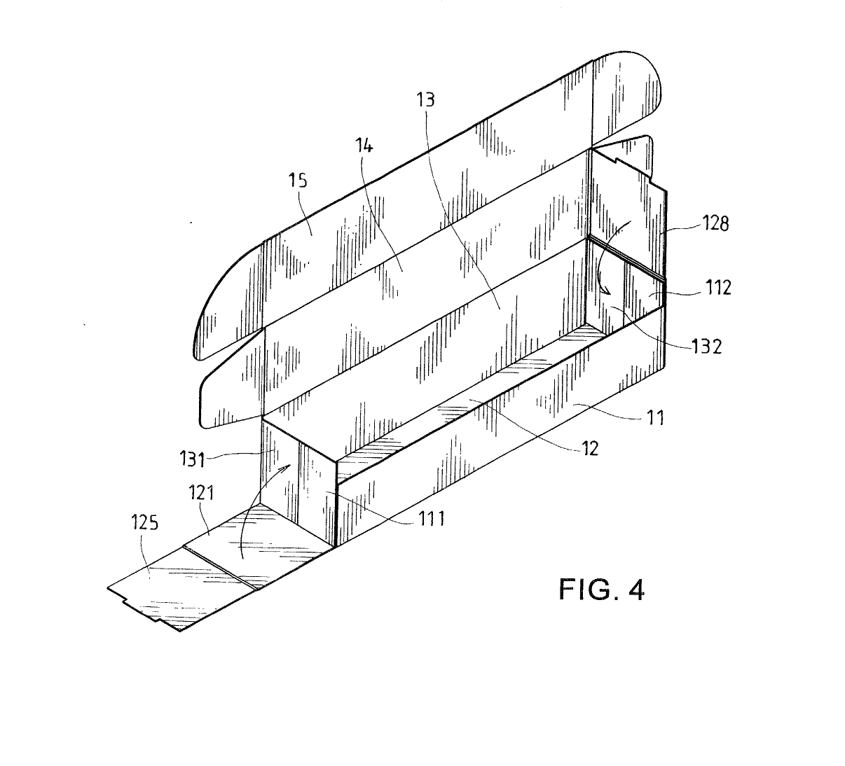

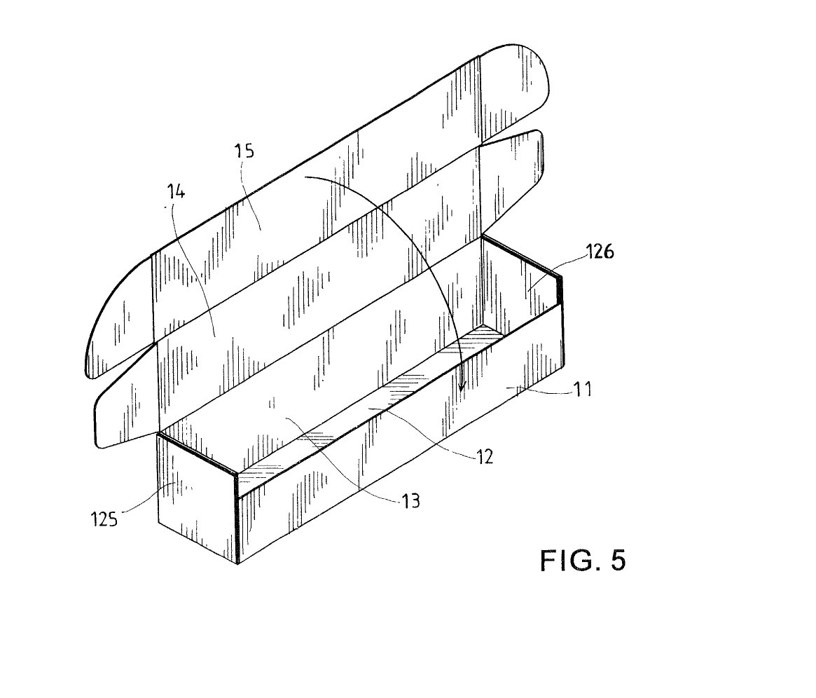

Referring to FIG. 2, which illustrate the first step of assembling the box body 10. As shown, the front side plate 11 is folded 90 degrees upward, and the enclosing plates 111, 112 on the two sides of the front side plate 11 are folded 90 degrees inward. Next, referring to FIG. 3, the rear side plate 13, the cover plate 14 and the front side cover plate 15 are folded 90 degrees upward, and the enclosing plates 151, 152 on the two sides of the rear side plate 15 are folded inward. Then, referring to FIG. 4, the enclosing plate 122 and the securing plate 126 on the right side of the bottom plate 12 are folded 90 degrees upward. At the same time, as shown in FIG. 5, the enclosing plate 121 and the securing plate on the left side of the bottom plate 12 are likewise folded 90 degrees upward. Thereafter, the securing plates 125, 126 are folded in a reverse direction such that they respectively surround the enclosing plates 111, 131, and the enclosing plates 112, 132, and lie flat against the inner sides thereof. Furthermore, the projecting portions 127, 128 at the distal ends of the securing plates 125, 126 are inserted into the elongate holes 123, 124 to enable the front side plate 11, the bottom plate 12 and the rear side plate 13 can be secured and form a box body that is capable of supporting the two support frames 30 and the plastic film wrap 40 without the use of any adhesive.

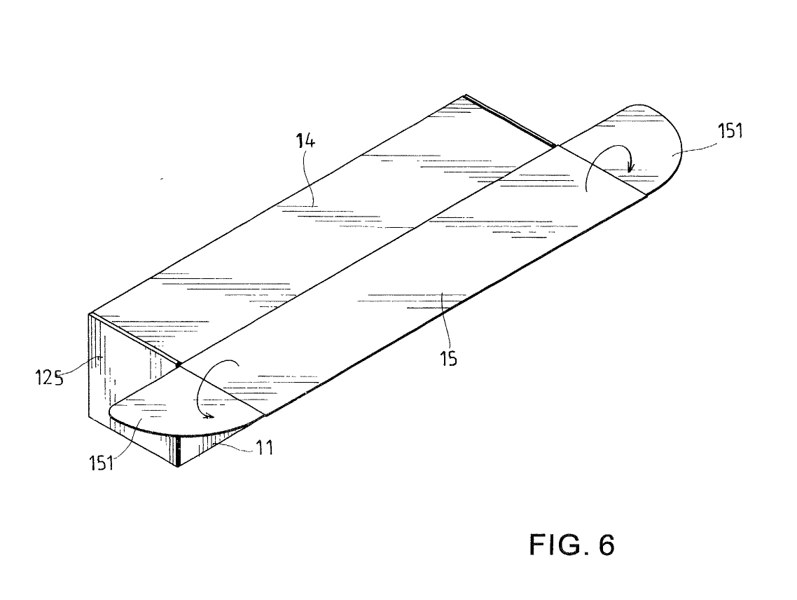

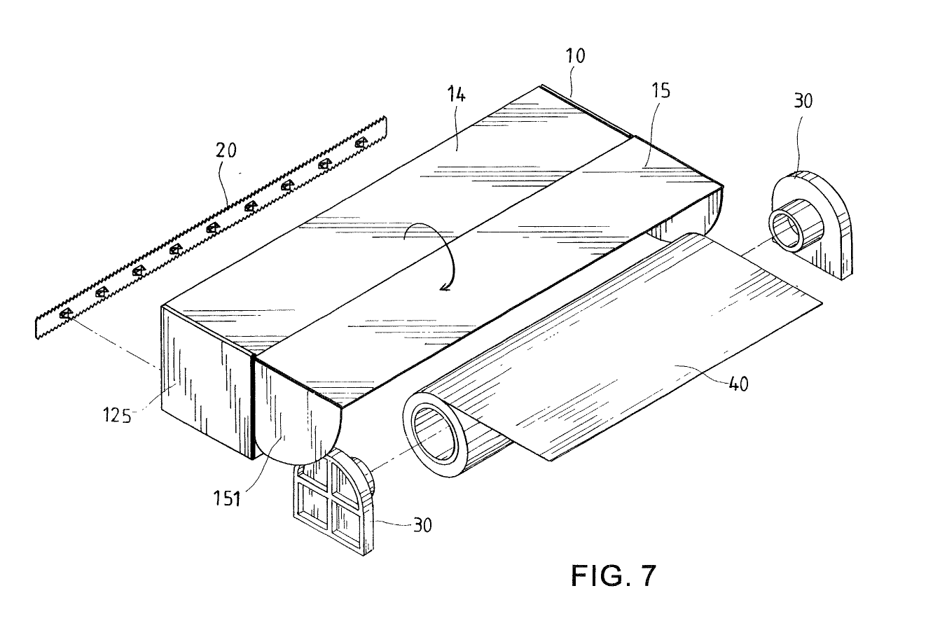

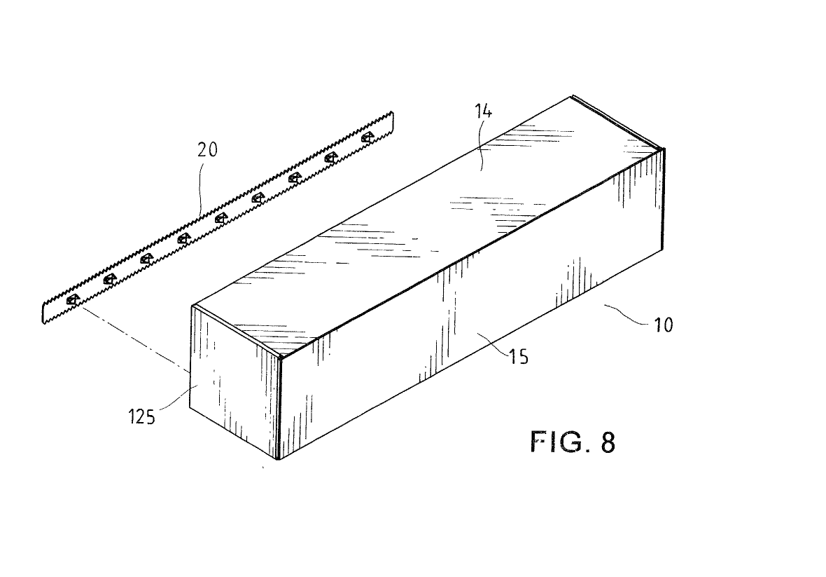

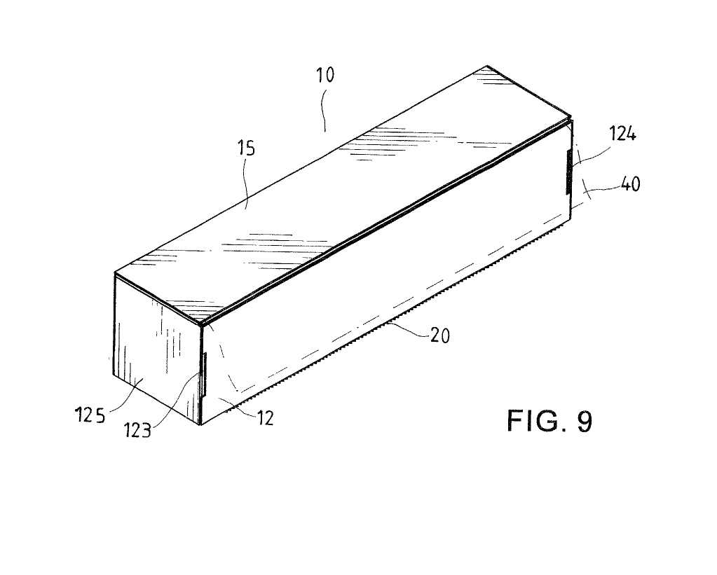

Referring to FIG. 6, the cover plate 14 and the front side cover plate 15 are folded 90 degrees so as to cover the box body. As shown in FIG. 7, the enclosing plates 151, 152 on the two sides of the front side plate 15 are respectively folded 90 degrees downward. Then, referring to FIG. 8, the front side cover plate 15 is folded 90 degrees downward to cover the side of the front side plate 11. Then, the enclosing plates 151, 152 on the two sides of the front side cover plate 15 are respectively inserted into gaps between the enclosing plates 121, 111 and 122, 112, thereby forming a rectangular box body. FIG. 9 shows the bottom side of the plastic film wrap packaging box after being turned about 90 degrees.

With further reference to FIGS. 1 to 6, another feature of the plastic film wrap packaging box of the present invention is that the height of the front side plate 11 is lower than that of the rear side plate 13 to thereby form a suitable opening 113 to facilitate pulling of the plastic film wrap.

Although the present invention has been illustrated and described with reference to the preferred embodiment thereof, it should be understood that it is in no way limited to the details of such embodiment but is capable of numerous modifications within the scope of the appended claims.

What is claimed is:

1. A plastic film wrap packaging box, comprising a front side plate, a bottom plate, a rear side plate, an upper cover plate and a front side cover plate, said bottom plate having two sides respectively provided with elongate holes, and two enclosing plates on the two sides which extend outwardly and respectively to form securing plates corresponding to said enclosing plates and respectively having projecting portions, said two securing plates being folded toward inner sides of said box body to surround enclosing plates on two sides of each of said front side plates and said rear side plates such that said projecting portions are inserted into said elongate holes in the two sides of said bottom plate to enable said front side plate, said bottom plate and said rear side plate to form a box body.

2. The plastic film wrap packaging box as claimed in claim 1, wherein said front side plate has a height lower than that of said rear side plate so as to form a suitable opening to facilitate pulling of plastic film wrap.
